(19) United States
(12) Patent Application Publication
(10) Pub. No.: US 2026/0326320 A1
(43) Pub. Date: Oct. 22, 2026

(54) HANDHELD POWERED SAFETY CUTTING DEVICE WITH LOAD-BEARING OSCILLATION ASSEMBLY

(71) Applicants: John Decker Spitz, Merrimack, NH (US); Robert K. Spitz, Nashua, NH (US); Rob Wright, Agoura Hills, CA (US)

(72) Inventors: John Decker Spitz, Merrimack, NH (US); Robert K. Spitz, Nashua, NH (US); Rob Wright, Agoura Hills, CA (US)

(73) Assignee: 214 Central Industries, Inc, Agoura Hills, CA (US)

(21) Appl. No.: 19/433,488

(22) Filed: Dec. 26, 2025

Related U.S. Application Data
(60) Provisional application No. 63/739,528, filed on Dec. 28, 2024.

(51) Int. Cl. B26B 7/00; B26B 5/00; B26B 29/00

(52) U.S. Cl. CPC B26B 7/00; B26B 5/005; B26B 5/006; B26B 29/00

(57) ABSTRACT

A handheld powered safety cutting device includes a housing configured for one-handed operation, an electric motor, and a cutting blade secured to a blade holder rigidly affixed to a pivot shaft. The pivot shaft is mounted for oscillatory rotational movement and is supported by bearing structures positioned in opposing support frames within the housing. A drive coupling between the motor and the pivot shaft imparts alternating rotational torque to oscillate the blade within a protected cutting slot formed using a replaceable blade guard. During cutting, lateral cutting forces are transmitted from the blade holder through the pivot shaft and distributed through the bearing structures to reduce localized wear, binding, vibration, and deflection during extended cutting operations. In some embodiments, an eccentric cam and a crowned ring engage a forked end of the blade holder to generate the alternating torque.

### CROSS-REFERENCE TO RELATED APPLICATIONS

This application claims priority to U.S. Provisional Patent Application No. 63/739,528, filed Dec. 28, 2024, entitled “HANDHELD POWERED SAFETY BOX CUTTER,” the entirety of which is incorporated herein by reference.

### FIELD OF THE INVENTION

The present invention relates generally to handheld powered cutting devices, and more particularly to safety-oriented cutting devices configured for cutting corrugated cardboard and similar sheet materials under sustained lateral loading conditions.

### BACKGROUND OF THE INVENTION

Corrugated cardboard is widely used in shipping, packaging, warehousing, and recycling applications. Disposal and recycling of cardboard typically requires cutting and breaking down boxes using long, continuous cutting strokes that generate substantial lateral forces on a cutting blade. Manual utility knives expose sharp blades and are a frequent source of injury. Powered cutting devices developed for consumer or food-preparation applications, such as electric knives, typically employ oscillating blade mechanisms optimized for slicing soft materials. Some devices often utilize blade holders mounted on fixed shafts or guides, which are adequate for low-load environments but may experience increased wear, friction, binding, vibration, and instability when subjected to the sustained lateral cutting forces encountered during cardboard cutting. Additionally, many powered cutting devices lack integrated safety systems that prevent blade motion during blade replacement or servicing, increasing the risk of accidental injury.

### SUMMARY OF THE INVENTION

The present invention provides a handheld powered safety cutting device that overcomes the limitations of prior art devices by employing a load-bearing oscillation architecture in which a cutting blade is driven by a rotationally oscillating pivot shaft supported by bearing structures.

In one aspect, the invention includes a pivot shaft mounted for oscillatory rotational movement and supported by bearing structures positioned on opposing sides of a blade holder. The blade holder is rigidly affixed to the pivot shaft such that the blade holder and pivot shaft rotate together as a single unit during operation. Lateral cutting forces generated during cutting are transmitted from the blade holder through the pivot shaft and distributed to the housing through the bearing structures, thereby reducing localized wear, binding, vibration, and deflection during extended cutting operations.

In another aspect, the invention includes a safety interlock system configured to disable motor operation when a blade access cover is removed, preventing exposure of a moving blade during blade replacement or servicing.

In another aspect, the invention includes a protected cutting slot with an inclined feed plane configured to guide sheet material toward the cutting blade reducing user-applied cutting force while maintaining separation between the blade and a user's fingers.

In a further aspect, the invention includes a method of cutting corrugated sheet material utilizing the described load-bearing oscillation architecture.

### BRIEF DESCRIPTION OF THE DRAWINGS

FIG. 1 is a side perspective view of a handheld powered safety cutting device (100) including an exterior housing (102), handle portion (104), activation switch (106), cutting head area (109), showing inclined feed plane with protected cutting slot (108), blade access cover (110), and replaceable blade guard (112).

FIG. 2 is an opposite side and rear perspective view of the device (100) showing the exterior housing (102), charging port (214) and optional safety plug (216).

FIG. 3 is a partial internal view of the cutting head of the device (100). It shows blade holder (302) and blade retaining screw (304). During operation, the cutting blade (306) is installed in the blade holder and protected by the replaceable blade guard (112). The blade guard separator edge (303) helps guide material after being cut.

FIG. 4 is a detailed internal view of the cutting assembly of device (100) showing an electric motor (401), drive coupling (404), pivot shaft (406) configured for oscillatory rotational movement, blade holder (302), and blade holder forked end (403).

FIG. 5 is a closeup cutaway view of the cutting assembly illustrating the blade holder (302) rigidly affixed to pivot shaft (406), and bearing-supported load structures (510) and (512) mounted on the internal rear support frame (514) and front support frame (516).

FIG. 6 is a full internal view of the device (100) showing the control circuit (606), electrical connections (608), and the interior cutting head assembly (400).

FIG. 7 is a full internal view of the device (100) showing a battery pack (710) installed within the housing (102). This figure also shows the blade access cover interlock safety switch (712).

### DETAILED DESCRIPTION OF THE INVENTION

In some embodiments, the motor shaft (402) turns a drive coupling mechanism (404). The drive coupling mechanism is composed of an eccentric cam (503) with a crowned ring (504) mounted on bearings (505) over the eccentric cam such that the crowned ring rotates relative to the eccentric cam. The crowned ring engages a forked end portion (403) of the blade holder. As the motor shaft rotates, the eccentric cam causes the crowned ring to apply alternating rotational torque to the pivot shaft (406) via the blade holder. The blade holder is rigidly affixed to a pivot shaft, and the applied alternating torque causes the pivot shaft to undergo oscillatory rotational movement about its longitudinal axis. The pivot shaft is supported by bearing structures positioned at opposing ends of the pivot shaft, permitting oscillatory rotation while resisting lateral cutting forces generated during cutting operations. In this configuration, the blade holder and pivot shaft rotate together as a single rigid assembly during oscillatory movement, and relative motion between the blade holder and the pivot shaft is prevented.

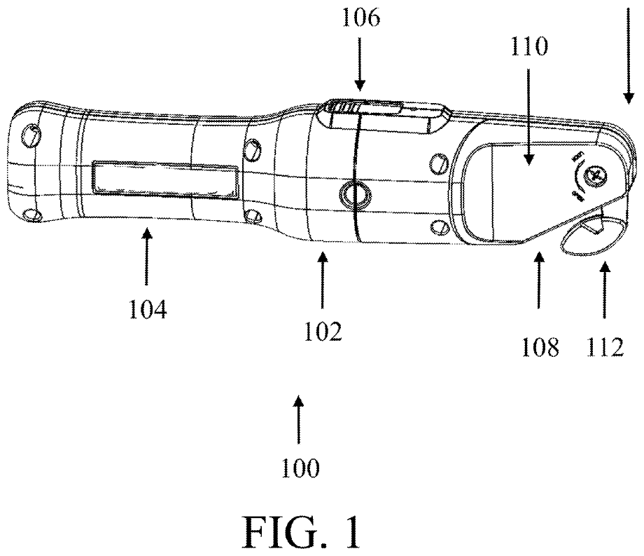

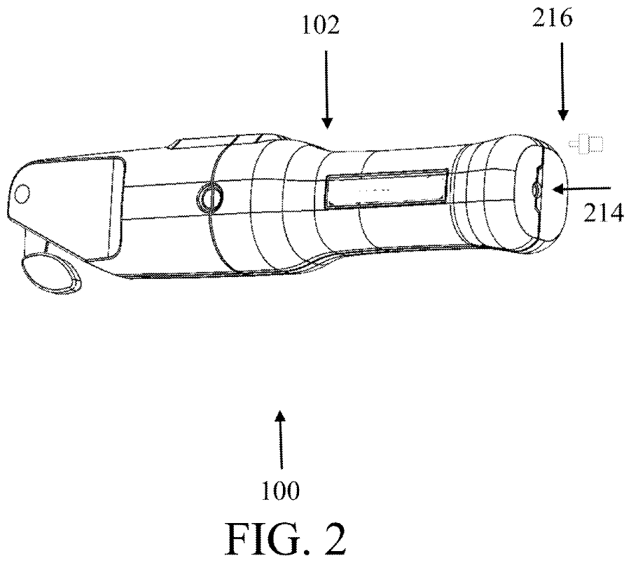

### General Housing and External Features (FIGS. 1-2)

Referring to FIGS. 1 and 2, a handheld powered safety cutting device (100) includes a housing (102) configured for one-handed operation and shaped to provide ergonomic gripping during extended cutting use. The activation switch (106) is positioned for optimal operation by depressing with the thumb. This orientation supports an efficient pulling motion for cutting.

The housing includes a handle portion (104), a cutting head portion (109), and a rear portion configured to house a power source. The housing may be formed from molded polymer, composite, metal, or combinations thereof, selected to provide strength, durability, and electrical insulation.

The housing includes a blade access cover (110) positioned at the cutting head (109). The blade access cover is removably secured to permit blade replacement while shielding the cutting blade during normal operation. The blade access cover may be secured by fasteners, latches, or snap-fit features.

A protected cutting slot (108) is formed at the cutting end of the housing. The cutting slot is sized to receive corrugated sheet material while preventing user contact with the cutting blade.

The geometry of the cutting slot constrains material entry while maintaining a physical barrier between the blade and a user's fingers. A replaceable blade guard (112) protects the operator from the oscillating cutting blade. Optional versions of the replaceable blade guard may be provided, including versions having wider end caps for added protection or serrated end caps to facilitate slicing sealing tape on cardboard boxes.

The housing may include one or more external ports, including a charging port (214) configured to receive an external power source for recharging an internal battery. In some embodiments, the housing further includes an optional removable safety plug (216) or locking element positioned at a rear portion of the housing. The optional safety plug may be used to disable operation, prevent unauthorized use, or provide a shipping or storage safety feature. When the safety plug is inserted into the charging port, it disables device operation.

Branding or identification regions may be formed on the exterior of the housing and may receive labels, markings, or logos.

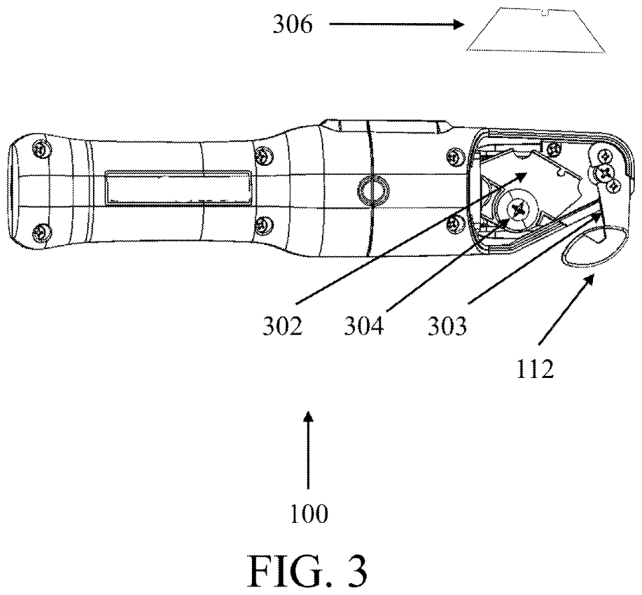

### Cutting Assembly and Rotating Pivot Shaf Architecture (FIGS. 3, 4, 5)

Referring to FIGS. 3, 4 and 5, the cutting assembly includes a cutting blade (306) secured to a blade holder (302). The blade holder is rigidly affixed to a pivot shaft (406) extending transversely relative to a cutting direction.

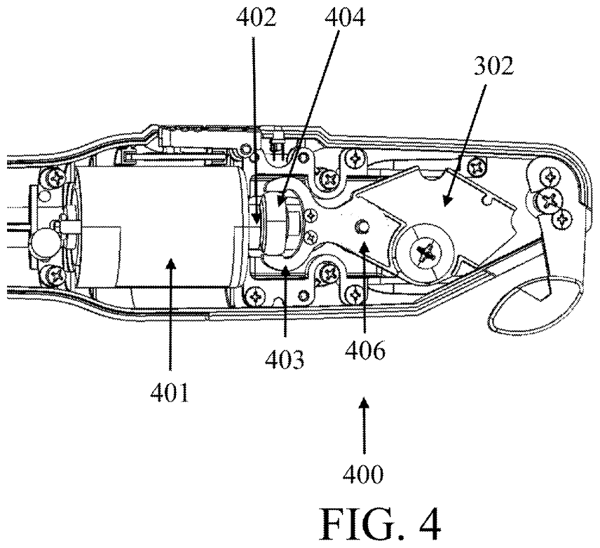

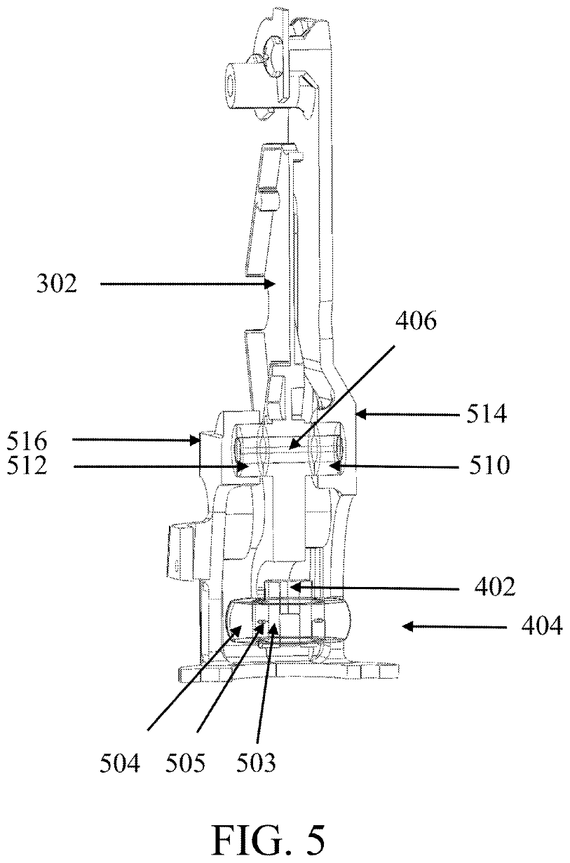

The pivot shaft is mounted for oscillatory rotational movement and is supported by bearing structures (510) and (512) positioned on opposing sides of the blade holder. As shown in FIGS. 4 and 5, the blade holder is rigidly affixed to a pivot shaft which is supported by bearings secured to internal rear (514) and front (516) support frames.

The bearing structures may include bushings or sleeve bearings, sintered bronze bearings, polymer composite bearings, ball bearings, or combinations thereof. The bearing structures support the pivot shaft within the housing and permit rotational oscillation while resisting lateral deflection.

The blade holder and pivot shaft rotate together as a single unit during operation. Oscillatory motion of the cutting blade is therefore produced by rotational oscillation of the pivot shaft, rather than by relative motion between the blade holder and a stationary shaft.

During cutting, lateral cutting forces generated by engagement of the cutting blade with corrugated sheet material are transmitted from the blade holder through the pivot shaft and distributed to the housing through the bearing structures. This load path distributes lateral forces across multiple bearing supports, reducing localized wear, friction, binding, vibration, and deflection during extended cutting operations.

The pivot shaft may extend through opposing front and rear support frames within the housing, and the bearing structures may be axially spaced along the pivot shaft to further distribute lateral loads.

### Motor and Drive Coupling (FIG. 4)

An electric motor (401) is mounted within the housing and operatively coupled to the pivot shaft (406) via a drive coupling (404). The drive coupling may include an eccentric cam, crank mechanism, or equivalent structure configured to impart alternating rotational torque to the pivot shaft. The eccentric cam applies alternating torque to the pivot shaft without imposing significant radial displacement of the pivot shaft, thereby maintaining bearing alignment during oscillation.

During operation, rotation of the motor causes the drive coupling to impart alternating rotational torque to the pivot shaft via the blade holder forked end (403), thereby producing oscillatory rotational movement of the blade holder and cutting blade.

The pivot shaft, blade holder, drive coupling, and bearing structures are dimensioned and selected to withstand sustained lateral cutting forces. Such forces may be produced during extended cutting operations and may include drag forces, shear forces, and side-loading forces generated during cutting of corrugated sheet material.

### Protected Cutting Slot, Inclined Feed Plane, and Separator Edge (FIGS. 1, 3, 4)

The protected cutting slot (108) includes an inclined feed plane oriented at an acute angle relative to a longitudinal handle axis. In some embodiments, the inclined feed plane is oriented between approximately 15 and 35 degrees relative to the handle axis.

During normal use, the inclined feed plane directs sheet material toward the cutting blade, assisting feeding of the sheet material into the cutting blade and reducing the amount of force a user must apply. The inclined feed plane maintains separation between the cutting blade and a user's fingers while allowing sheet material to be guided smoothly into the cutting path.

In some embodiments, a blade guard separator edge (303) is positioned downstream of the cutting blade within the cutting slot. The separator edge is shaped to direct cut material away from the blade and reduces jamming as material exits the cutting slot following cutting.

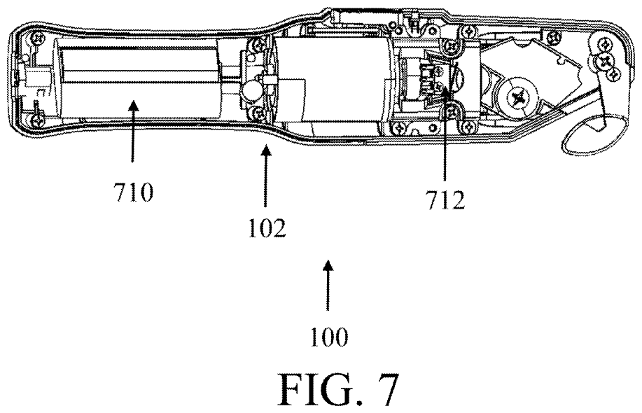

### Safety Interlock System (FIGS. 1, 7)

The blade access cover is operatively coupled to a safety interlock switch (712) positioned within the housing. The safety interlock switch is electrically connected to a control circuit.

When the blade access cover is removed or displaced from a closed position, the safety interlock switch causes the control circuit to disable motor operation, thereby preventing oscillation of the cutting blade while exposed. This configuration prevents accidental contact with a moving blade during blade replacement or servicing.

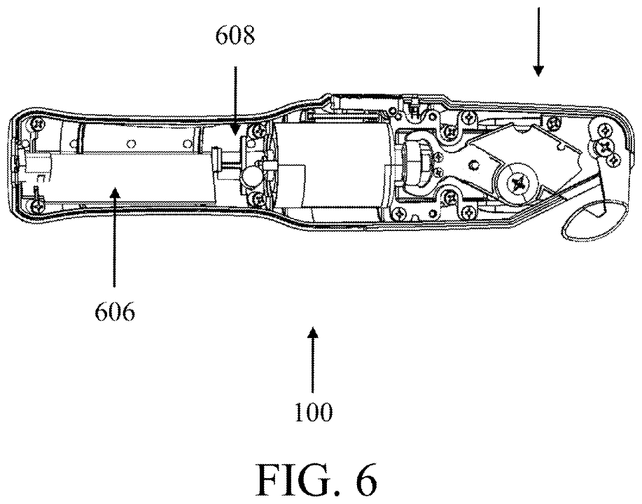

### Control Circuit and Electronics (FIG. 6)

The device includes a control circuit board (606) positioned within the housing. The control circuit is electrically connected to the motor, safety interlock switch, and power source.

In some embodiments, the control circuit includes one or more of over-current protection, short-circuit protection, automatic time-based motor shutoff, and battery-responsive motor control configured to adjust motor drive based on battery voltage.

Electrical connections between the control circuit, motor, safety interlock switch, and power source are routed through internal wiring paths within the housing.

### Power Source and Battery Compartment (FIGS. 2, 7)

The housing includes a battery compartment configured to receive a rechargeable battery pack (710). The battery pack is located adjacent to the control circuit (606). The battery pack is recharged via the charging port and provides electrical power to the motor and control circuit.

An optional safety plug (216) can be inserted into the charging port to disable operation. The battery pack may be removable or permanently installed, depending on the embodiment.

Electrical contacts connect the battery pack to the control circuit.

### Force-Path Comparison and Load Distribution (FIG. 5)

FIG. 5 illustrates the cutting assembly of the present invention, in which lateral cutting forces on the blade holder (302) are transmitted through a rotating pivot shaft (406) and distributed through bearing structures positioned on opposing sides of the blade holder. The bearings are mounted in durable internal rear (514) and front (516) support frames. This redistribution of lateral forces reduces localized stress, wear, binding, vibration, and deflection during extended cutting operations. This contrasts with fixed-shaft oscillation architectures in which lateral forces are concentrated at a blade holder pivot axle junction.

### Method of Cutting Corrugated Sheet Material

In operation, corrugated sheet material is guided into the protected cutting slot and along the inclined feed plane. The cutting blade is oscillated by rotationally oscillating the pivot shaft to which the blade holder is rigidly affixed. Lateral cutting forces generated during cutting are transmitted from the blade holder through the pivot shaft and into the bearing structures, where the forces are distributed across the housing during extended cutting operations.

1. A handheld powered safety cutting device for cutting corrugated sheet material, comprising:
a housing configured for one-handed operation;
an electric motor disposed within the housing;
a pivot shaft extending transversely relative to a cutting direction, the pivot shaft being mounted for oscillatory rotational movement and supported by bearing structures positioned in opposing front and rear support frames;
a blade holder rigidly affixed to the pivot shaft such that the blade holder and pivot shaft rotate together as a single unit during operation;
a cutting blade secured to the blade holder;
a drive coupling between the motor and the pivot shaft configured to impart alternating rotational torque to the pivot shaft; and
a protected cutting slot formed in the housing using a replaceable blade guard and positioned to guide corrugated sheet material into engagement with the cutting blade;
wherein lateral cutting forces generated during cutting are transmitted from the blade holder through the pivot shaft and distributed to the front and rear support frames through the bearing structures, reducing localized wear, binding, and deflection during extended cutting operations.

2. The device of claim 1, wherein the bearing structures comprise first and second bearings axially spaced along the pivot shaft.

3. The device of claim 2, wherein the bearings are selected from sleeve bearings, sintered bronze bearings, polymer composite bearings, or ball bearings.

4. The device of claim 1, wherein oscillatory motion of the cutting blade is produced by rotational oscillation of the pivot shaft rather than relative motion between the blade holder and a stationary shaft.

5. The device of claim 1, wherein the pivot shaft extends through opposing front and rear support frames.

6. The device of claim 1, wherein the drive coupling comprises an eccentric cam driven by a motor shaft and a crowned ring mounted on bearings over the eccentric cam, the crowned ring being configured to engage a forked end of the blade holder to impart alternating rotational torque to the pivot shaft.

7. The device of claim 1, wherein the pivot shaft and bearing structures are dimensioned to withstand sustained lateral forces produced during long cutting strokes through corrugated cardboard.

8. A handheld powered safety cutting device, comprising:
a housing enclosing a motor-driven oscillating cutting blade;
a removable blade access cover configured to permit blade replacement;
a safety interlock switch operatively coupled to the blade access cover;
a control circuit electrically connected to the motor and the safety interlock switch;
wherein the control circuit is configured to disable motor operation when the blade access cover is removed.

9. The device of claim 8, wherein the control circuit includes over-current protection.

10. The device of claim 8, wherein the control circuit includes short-circuit protection.

11. The device of claim 8, wherein the control circuit includes an automatic time-based motor shutoff.

12. The device of claim 8, wherein the control circuit dynamically adjusts motor drive based on battery voltage.

13. A method of cutting corrugated sheet material using a handheld powered cutting device, comprising:
guiding corrugated sheet material into a protected cutting slot;
oscillating a cutting blade by rotationally oscillating a pivot shaft to which a blade holder is rigidly affixed;
supporting the pivot shaft on bearing structures positioned on opposing sides of the blade holder;
transmitting lateral cutting forces from the blade holder through the pivot shaft and into the bearing structures; and
distributing the lateral cutting forces across front and rear support frames of the device during extended cutting operations.

14. The method of claim 13, wherein oscillating the pivot shaft comprises applying alternating rotational torque from an electric motor.

15. The method of claim 13, wherein the corrugated sheet material is cut using long, continuous cutting strokes.

16. The method of claim 13, further comprising disabling motor operation when a blade access cover is removed.

17. The device of claim 1, wherein the protected cutting slot includes an inclined feed plane oriented at an acute angle relative to a handle axis.

18. The device of claim 17, wherein the inclined feed plane is oriented between approximately 15 and 35 degrees.

19. The device of claim 1, further comprising a blade guard separator edge positioned downstream of the cutting blade to reduce jamming.

20. The device of claim 1, wherein the inclined feed plane and blade guard separator edge cooperate to reduce user-applied cutting force while maintaining separation between the cutting blade and a user's fingers.
